(19) United States
(12) Patent Application Publication
(10) Pub. No.: US 2015/0188382 A1
(43) Pub. Date: Jul. 2, 2015

(54) SPINDLE MOTOR

(71) Applicant: SAMSUNG ELECTRO-MECHANICS CO., LTD., Suwon-Si (KR)

(72) Inventor: Viatcheslav SMIRNOV, Suwon-Si (KR)

(73) Assignee: SAMSUNG ELECTRO-MECHANICS CO., LTD., Suwon-Si (KR)

(21) Appl. No.: 14/543,903

(22) Filed: Nov. 18, 2014

(30) Foreign Application Priority Data
Dec. 30, 2013 (KR) 10-2013-0167424

(51) Int. Cl. H02K 5/24

(52) U.S. Cl. CPC H02K 5/24

(57) ABSTRACT

There is provided a spindle motor including: a base member including a sleeve insertion part protruding in an axial direction; a core coupling portion coupled to an outer surface of the sleeve insertion part; and a stator core mounted on the core coupling portion, wherein one end of the core coupling portion is provided with a flange portion extended along a bottom surface of the base member and supporting the stator core.

### CROSS-REFERENCE TO RELATED APPLICATION

This application claims the priority and benefit of Korean Patent Application No. 10-2013-0167424 filed on Dec. 30, 2013, with the Korean Intellectual Property Office, the disclosure of which is incorporated herein by reference.

### BACKGROUND

The present disclosure relates to a spindle motor, and more particularly, to a spindle motor in which horizontality of a stator core is improved.

A hard disk drive (HDD), an information storage device, reads data stored on a disk or writes data to a disk using a read/write head.

Such a hard disk drive requires a disk driving device capable of driving the disk. In the disk driving device, a spindle motor is used.

In addition, a disk is mounted on the motor, and at the time of rotation of the disk, data stored on the disk may be read.

Here, the motor rotating the disk, which is a device converting electrical energy into mechanical energy using force induced in a conductor having a current flowing therein within a magnetic field, basically generates driving force rotating the disk by electromagnetic interaction between a magnet and a coil.

Meanwhile, the coil is wound around a stator core, and the stator core is installed on a base member so as to be disposed to face the magnet. That is, the stator core is fixedly installed in a sleeve housing of the base member so as to be disposed to face the magnet.

However, in the case of installing the stator core in a core coupling portion, the stator core may be installed in the core coupling portion in an inclined state. In this case, the centers of the stator core and the magnet may not coincide with each other. Therefore, cogging torque may be non-uniform, and as a result, noise dispersion may be increased at the time of driving the motor.

### SUMMARY

An aspect of the present disclosure may provide a spindle motor in which horizontality of a stator core may be improved at the time of installing the stator core in the spindle motor.

According to an aspect of the present disclosure, a spindle motor may include: a base member including a sleeve insertion portion protruding in an axial direction; a core coupling portion coupled to an outer surface of the sleeve insertion portion; and a stator core mounted on the core coupling portion, wherein the core coupling portion includes a flange portion extended along a bottom surface of the base member and supporting the stator core.

The flange portion may include a coil accommodating portion penetrating through the flange portion.

The flange portion may be at least partially provided at one end of the core coupling portion.

The flange portion may include a core supporting portion protruding from the flange portion so as to support the stator core.

The stator core may include: a ring shaped coreback mounted on an outer peripheral surface of the core coupling portion; a plurality of extending portions extended from the coreback; and expanding portions extended from the extending portions and expanded in a circumferential direction, and the core supporting portion may be provided so as to come into contact with a bottom surface of the expanding portion.

Portions of bottom surfaces adjacent to expanding portions of the stator core may come into contact with each other on the core supporting portion.

The core supporting portion may have a cylindrical shape or a polygonal columnar shape.

An end portion of the sleeve insertion portion may be bent toward an inner portion thereof, such that a side wall of the sleeve insertion portion may be doubly provided.

According to another aspect of the present disclosure, a spindle motor may include: a base member including a sleeve insertion portion protruding in an axial direction; a core coupling portion coupled to an outer surface of the sleeve insertion portion; a flange portion extended from the core coupling portion along a bottom surface of the base member and coupled to a fixing portion protruding from the base member; and a stator core mounted on the core coupling portion, wherein the flange portion is disposed so as to support a bottom surface of the stator core.

A through hole may be provided in the flange portion, and the fixing portion may be press-fitted into the through hole to thereby be coupled thereto.

The flange portion may include a coil accommodating portion penetrating through the flange portion.

The flange portion may be at least partially provided at one end of the core coupling portion.

The stator core may include: a ring shaped coreback mounted on an outer peripheral surface of the core coupling portion; a plurality of extending portions extended from the coreback; and expanding portions extended from the extending portions and expanded in a circumferential direction, and the flange portion may be provided so as to come into contact with a bottom surface of the expanding portion and support the stator core.

The fixing portion may have a cylindrical shape or a polygonal columnar shape.

An end portion of the sleeve insertion portion may be bent toward an inner portion thereof, such that a side wall of the sleeve insertion portion may be doubly provided.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a spindle motor according to an exemplary embodiment of the present disclosure;

FIG. 2 is an exploded perspective view of a base member and a core coupling portion of FIG. 1;

FIG. 3 is a perspective view of the core coupling portion illustrated in FIG. 2;

FIG. 4 is a schematic cross-sectional view of a spindle motor according to another exemplary embodiment of the present disclosure;

FIG. 5 is an exploded perspective view of a base member and a core coupling portion of FIG. 4;

FIG. 6 is a perspective view of the core coupling portion illustrated in FIG. 5;

FIG. 7 is a schematic cross-sectional view of a spindle motor according to another exemplary embodiment of the present disclosure;

FIG. 8 is an exploded perspective view of a base member and a core coupling portion of FIG. 7;

FIG. 9 is a perspective view of the core coupling portion illustrated in FIG. 8; and

FIG. 10 is a perspective view of a stator core according to an exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

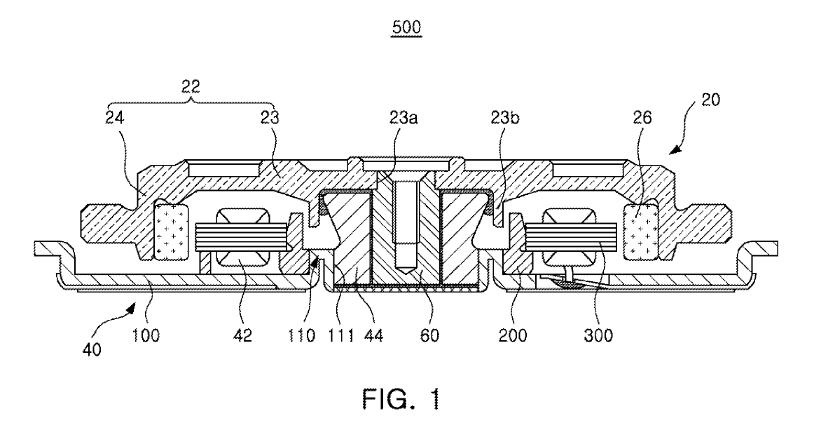

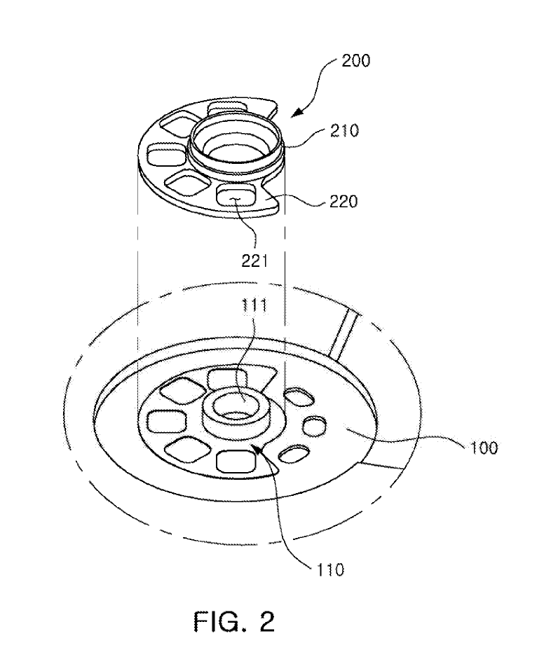

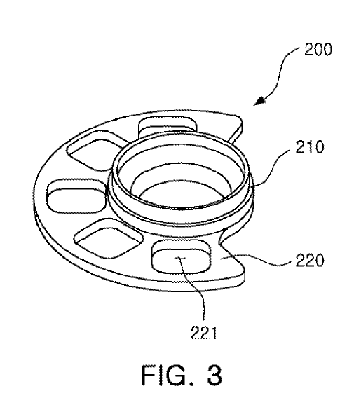

FIG. 1 is a schematic cross-sectional view of a spindle motor according to an exemplary embodiment of the present disclosure, FIG. 2 is an exploded perspective view of a base member and a core coupling portion of FIG. 1, and FIG. 3 is a perspective view of the core coupling portion illustrated in FIG. 2.

Referring to FIGS. 1 through 3, a spindle motor 500 according to an exemplary embodiment of the present disclosure may include a base member 100, a core coupling portion 200, and a stator core 300.

Meanwhile, the spindle motor 500 may be a motor used in a recording disk driving device rotating a recording disk, and may include a rotor 20 and a stator 40.

The rotor 20 may include a cup-shaped rotor case 22 in which an annular ring shaped magnet 26 corresponding to the stator core 300 is installed.

In addition, the annular ring shaped magnet 26 may be a permanent magnet in which an N pole and an S pole are alternately magnetized in a circumferential direction to generate magnetic force having a predetermined strength.

Further, the rotor case 22 may include a body 23 in which an installation hole 23a in which a shaft 60 is installed and a main wall part 23b for sealing oil between the rotor case 22 and the shaft 60 are formed and a magnet coupling part 24 extended downwardly from an edge of the body 23 in an axial direction.

In addition, the magnet coupling part 24 may include the magnet 26 installed on an inner surface thereof.

The stator 40, which means all fixing members with the exception of a rotating member, may include the stator core 300, a winding coil 42 enclosing the stator core 300, a sleeve 44, and the base member 100.

Meanwhile, the magnet 26 mounted on the inner surface of the magnet coupling part 24 maybe disposed to face the stator core 300 having the winding coil 42 wound therearound, and the rotor 20 may rotate through interaction between magnetic force of the magnet 26 and electric force by a current supplied to the winding coil 42, in other words, electromagnetic interaction.

That is, the rotor case 22 may rotate through interaction between the magnetic force from the magnet 26 and electric force by the current supplied to the winding coil 42, and the shaft 60 may rotate together with the rotor case 22.

Here, terms with respect to directions will be defined. An axial direction means a vertical direction based on the shaft 60 when being viewed in FIG. 1, a radial direction refers to a direction toward an outer edge of the rotor case 22 based on the shaft 60 or a central direction of the shaft 60 based on the outer edge of the rotor case 22, and a circumferential direction refers to a direction of rotation along an outer circumferential surface of the shaft 60.

The base member 100 may be formed by performing plastic working on a steel plate. For example, the base member 100 may be manufactured by a forging or pressing process, and manufactured by disposing a plate shaped steel material, which becomes a base material, in a pressing mold and pressing the plate shaped steel material at a predetermined pressure. In addition, the base member 100 may include a sleeve insertion portion 110 in which the sleeve 44 is inserted and installed. The sleeve insertion portion 110 may be formed integrally with the base member 100. Alternatively, the sleeve insertion portion 110 may be separately manufactured and then coupled to the base member 100.

In addition, the sleeve insertion portion 110 may be provided so as to protrude upwardly in the axial direction and include a mounting hole 111 into which the sleeve 44 may be inserted. That is, the sleeve insertion portion 110 may have an entirely cylindrical shape.

Further, an end portion of the sleeve insertion portion 110 may be bent toward an inner portion thereof, such that a side wall of the sleeve insertion portion 110 may be doubly provided. This double side wall structure may enhance rigidity of the sleeve insertion portion 110.

Meanwhile, the sleeve 44 may be fixedly installed in the sleeve insertion portion 110 by an adhesive. That is, the adhesive may be applied to an outer peripheral surface of the sleeve 44 and an inner surface of the side wall of the sleeve insertion part 110, such that the sleeve 44 may be fixedly installed into the sleeve insertion part 110.

The core coupling portion 200 may be coupled to an outer surface of the sleeve insertion part 110. That is, the core coupling portion 200 may be coupled to the outer surface of the sleeve insertion part 110 by a slide method, a press-fitting method, or a bonding method. However, various coupling methods may be used.

Here, the core coupling portion 200 may include a seating part 210 on which the stator core 300 is seated and a flange portion 220.

The seating part 210 maybe provided at an outer surface of the core coupling portion 200, and the stator core 300 may be fixedly installed to the outer surface of the core coupling portion 200 in a state in which the stator core 300 is seated on the seating part 210.

Meanwhile, the core coupling portion 200 may include the flange portion 220 extended along a bottom surface of the base member 100. Here, the flange portion 220 may be entirely formed on one end of the core coupling portion 200 or be at least partially provided at one end of the core coupling portion 200.

The flange portion 220 as described above may be provided below the stator core 300 to support a bottom surface of the stator core 300. That is, the flange portion 220 may be provided so as to come into contact with the bottom surface of the stator core 300 in order to support the stator core 300.

As a result, a horizontality of the stator core 300 may be improved by the flange portion 220. Meanwhile, the flange portion 220 may include a coil accommodating portion 221 penetrating through the flange portion 220. However, the flange portion 220 may include the coil accommodating portion 221 formed by depressing one portion of the flange portion 220 instead of penetrating through the flange portion 220.

The coil accommodating portion 221 as described above is to secure a space in which the coil wound around the stator core 300 may be provided, and the winding coil 42 may be positioned in the coil accommodating portion 221.

That is, the flange portion 220 may prevent a contact with the stator core 300 by including the coil accommodating portion 221.

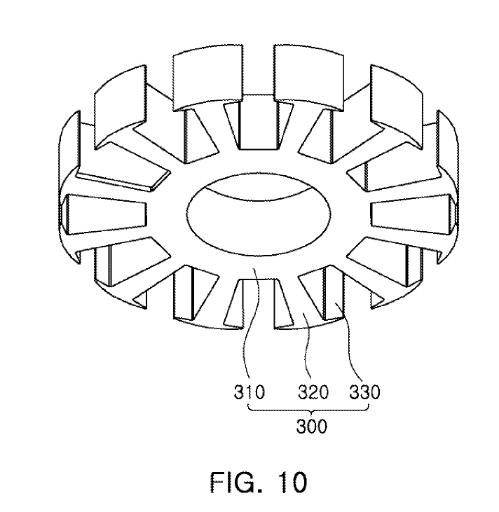

Referring to FIG. 10, the stator core 300 may be mounted on the core coupling portion 200. That is, the stator core 300 may be coupled to the core coupling portion 200 in a state in which the stator core is seated on the seating part 210 provided on the outer surface of the core coupling portion 200 as described above, and as a coupling method, various coupling methods such as a sliding method, a press-fitting method, a bonding method, and the like, may be used.

Here, the stator core 300 may include a ring shaped coreback 310 mounted on the outer surface of the core coupling portion 200, a plurality of extending portions 320 extended from the coreback 310, and expanding portions 330 extended from the extending portions 320 and expanded in the circumferential direction.

In other words, the stator core 300 may be coupled to the core coupling portion 200 so that a bottom surface of the coreback 310 is seated on the seating part 210 formed on the outer surface of the core coupling portion 200. In this case, an adhesive may be applied to an inner peripheral surface of the coreback 310 and an outer peripheral surface of the core coupling portion 200, such that the coreback 310 and the core coupling portion 200 may be coupled to each other.

In addition, the extending part 320 may have a bar shape so that the winding coil 42 may be wound therearound.

Meanwhile, the bottom surface of the stator core 300 disposed so as to come into contact with the flange portion 220 or a core supporting portion 222 provided at the flange portion 220 may mean the expanding portion 330.

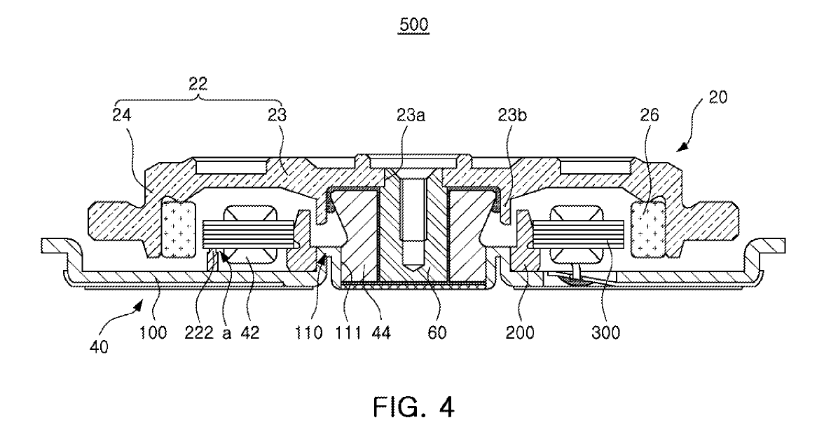

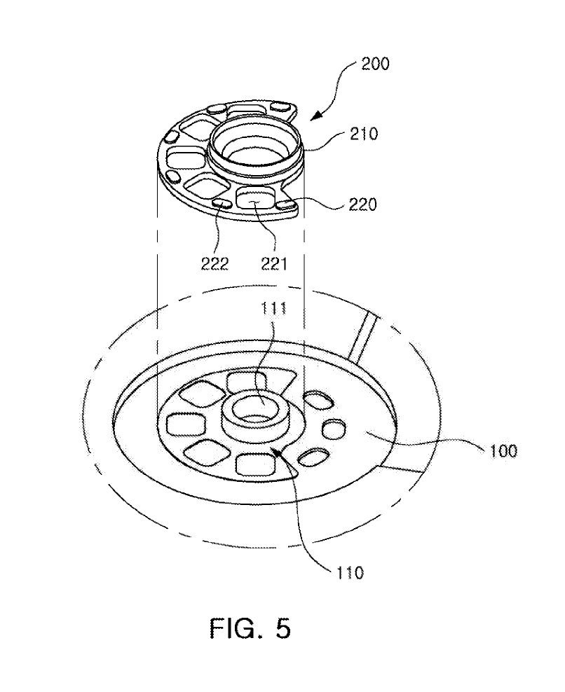

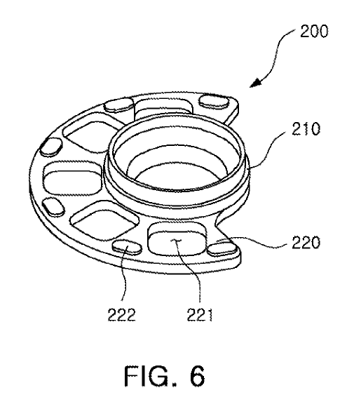

FIG. 4 is a schematic cross-sectional view of a spindle motor according to another exemplary embodiment of the present disclosure, FIG. 5 is an exploded perspective view of a base member and a core coupling portion of FIG. 4, and FIG. 6 is a perspective view of the core coupling portion illustrated in FIG. 5.

Here, other configurations of the spindle motor according to another exemplary embodiment of the present disclosure are the same as those of the spindle motor illustrated in FIGS. 1 through 3, but only a shape of the core coupling portion may be different. Therefore, a detailed description of the same configurations will be omitted and be replaced with the above-mentioned description.

A separate core supporting portion 222 may be provided at a flange portion 220 of the core coupling portion 200 according to another exemplary embodiment of the present disclosure so as to support the stator core 300. Therefore, in the case in which the separate core supporting portion 222 is provided at the flange portion 220, an air gap (a) may be formed between an upper surface of the flange portion 220 and the stator core 300.

The core supporting portion 222 as described above, which is formed integrally with the flange portion 220, may be provided so as to come into contact with the bottom surface of the stator core 300 to thereby support the stator core 300.

That is, the core supporting portion 222 may be provided so that portions of bottom surfaces adjacent to expanding portions 330 come into contact with each other on an upper surface of the core supporting portion 222.

In addition, the core supporting portion 222 may have various shapes. That is, the core supporting portion 222 may have a cylindrical shape or a polygonal columnar shape.

As a result, a horizontality of the stator core 300 may be improved by the core supporting portion 222 as described above.

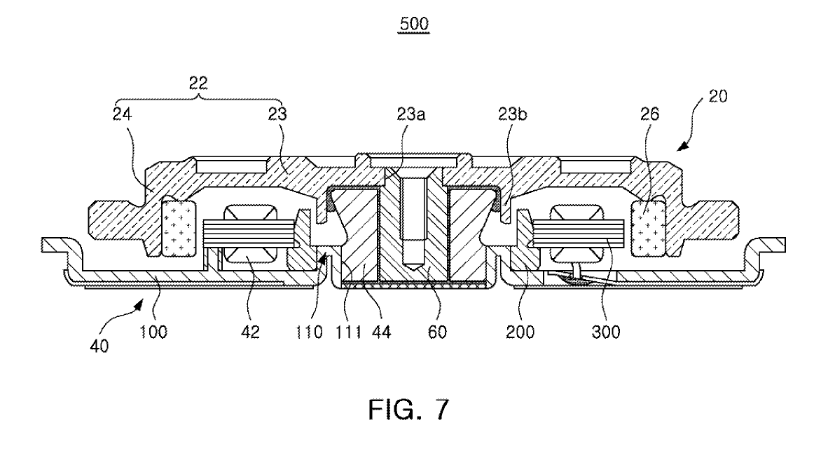

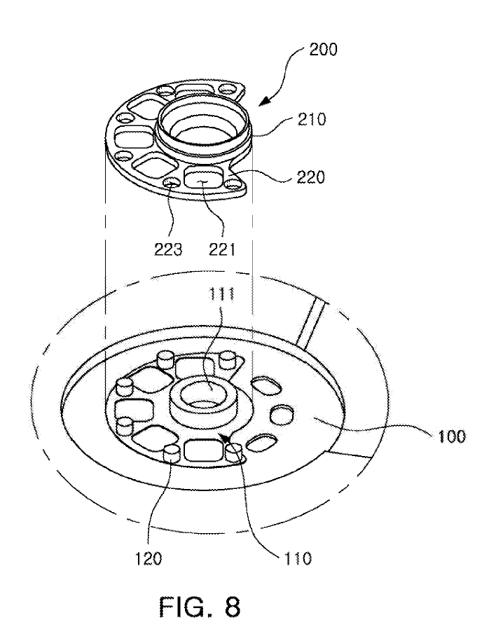

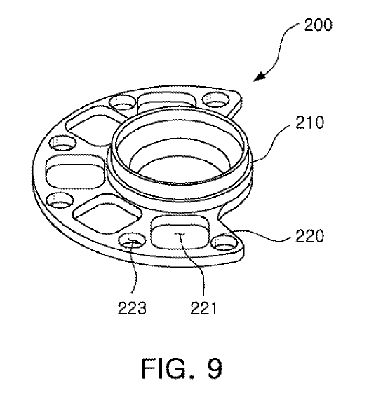

FIG. 7 is a schematic cross-sectional view of a spindle motor according to another exemplary embodiment of the present disclosure, FIG. 8 is an exploded perspective view of a base member and a core coupling portion of FIG. 7, and FIG. 9 is a perspective view of the core coupling portion illustrated in FIG. 8.

Referring to FIGS. 7 through 9, a spindle motor 500 according to another exemplary embodiment of the present disclosure may include a base member 100, a core coupling portion 200, and a stator core 300.

Here, in the case of the spindle motor 500 according to another exemplary embodiment of the present disclosure, only shapes of the base member 100 and the core coupling portion 200 and a coupling method thereof may be different from those in the spindle motors illustrated in FIGS. 1 through 6.

Therefore, a detailed description of the same configurations will be omitted and be replaced with the above-mentioned description, and hereinafter, the base member 100 and the core coupling portion 200 according to another exemplary embodiment of the present disclosure will be described.

The base member 100 may include a fixing portion 120 protruding from the base member 100. The fixing portion 120, which is provided integrally with the base member 100, may be press-fitted into a through hole 223 provided in the flange portion 220.

Here, the fixing portion 120 may be provided so as to correspond to the through hole 223, and may have various shapes such as a cylindrical shape, a polygonal columnar shape, or the like.

Further, a plurality of fixing portions 120 may be provided so as to correspond to the through hole 223, and the plurality of fixing portions 120 as described above may be spaced apart from each other.

Meanwhile, the through hole 223 may be provided in the flange portion 220 of the core coupling portion 200 so that the fixing portion 120 may be press-fitted therein.

Here, a plurality of through holes 223 may be provided so as to be spaced apart from each other with the coil accommodating portion 221 interposed therebetween. The core coupling portion 200 may be firmly coupled to the base member 100 by press-fitting of the through hole 223 and the fixing portion 120 as described above.

In addition, the bottom surface of the stator core 300 maybe disposed so as to come into contact with the flange portion 220 to thereby be supported by the flange portion 220.

As set forth above, according to exemplary embodiments of the present disclosure, the horizontality of the stator core may be improved by supporting the bottom surface of the stator core through the flange portion, such that generation of noise that may be generated during the driving may be decreased.

While exemplary embodiments have been shown and described above, it will be apparent to those skilled in the art that modifications and variations could be made without departing from the scope of the present invention as defined by the appended claims.

What is claimed is:

1. A spindle motor comprising:
a base member including a sleeve insertion part protruding in an axial direction;
a core coupling portion coupled to an outer surface of the sleeve insertion part; and
a stator core mounted on the core coupling portion,
wherein the core coupling portion includes a flange portion extended along a bottom surface of the base member and supporting the stator core.

2. The spindle motor of claim 1, wherein the flange portion includes a coil accommodating portion penetrating through the flange portion.

3. The spindle motor of claim 1, wherein the flange portion is at least partially provided at one end of the core coupling portion.

4. The spindle motor of claim 1, wherein the flange portion includes a core supporting portion protruding from the flange portion so as to support the stator core.

5. The spindle motor of claim 4, wherein the stator core includes:
a ring shaped coreback mounted on an outer peripheral surface of the core coupling portion;
a plurality of extending portions extended from the coreback; and
expanding portions extended from the extending portions and expanded in a circumferential direction, and
the core supporting portion is provided so as to come into contact with a bottom surface of the expanding portion and supports the stator core.

6. The spindle motor of claim 5, wherein portions of bottom surfaces adjacent to expanding portions of the stator core come into contact with each other on the core supporting portion.

7. The spindle motor of claim 4, wherein the core supporting portion has a cylindrical shape or a polygonal columnar shape.

8. The spindle motor of claim 1, wherein an end portion of the sleeve insertion part is bent toward an inner portion of the sleeve insertion part, such that a side wall of the sleeve insertion part is doubly provided.

9. A spindle motor comprising:
a base member including a sleeve insertion part protruding in an axial direction;
a core coupling portion coupled to an outer surface of the sleeve insertion part;
a flange portion extended from the core coupling portion along a bottom surface of the base member and coupled to a fixing portion protruding from the base member; and
a stator core mounted on the core coupling portion,
wherein the flange portion is disposed so as to support a bottom surface of the stator core.

10. The spindle motor of claim 9, wherein a through hole is provided in the flange portion, and the fixing portion is press-fitted into the through hole to thereby be coupled thereto.

11. The spindle motor of claim 9, wherein the flange portion includes a coil accommodating portion penetrating through the flange portion.

12. The spindle motor of claim 9, wherein the flange portion is at least partially provided at one end of the core coupling portion.

13. The spindle motor of claim 9, wherein the stator core includes:
a ring shaped coreback mounted on an outer peripheral surface of the core coupling portion;
a plurality of extending portions extended from the coreback; and
expanding portions extended from the extending portions and expanded in a circumferential direction, and
the flange portion is provided so as to come into contact with a bottom surface of the expanding portion and supports the stator core.

14. The spindle motor of claim 9, wherein the fixing portion has a cylindrical shape or a polygonal columnar shape.

15. The spindle motor of claim 9, wherein an end portion of the sleeve insertion part is bent toward an inner portion of the sleeve insertion part, such that a side wall of the sleeve insertion part is doubly provided.
